(19) United States
(12) Patent Application Publication
(10) Pub. No.: US 2004/0250251 A1
(43) Pub. Date: Dec. 9, 2004

(54) Overload protection for control units in communications networks

(76) Inventors: Peter Leis, Penzberg (DE); Rainer Liebhart, Schrobenhausen (DE)

Correspondence Address: Siemens Corporation, Intellectual Property Department, 170 Wood Avenue South, Iselin, NJ, 08830, US

(21) Appl. No.: 10/493,129

(22) PCT Filed: Oct. 17, 2002
(86) PCT No.: PCT/DE02/03932

(30) Foreign Application Priority Data
Oct. 19, 2001 (DE) 101 51 720.3

(51) Int. Cl. G06F 9/455; G06F 15/16

(52) U.S. Cl. 718/105; 709/235

(57) ABSTRACT

Control units, such as e.g. gatekeepers, which operate according to the H.323 standard are protected against H.225 signalling overload by the denial of call requests that have no prospect of success according to the H.323 protocol specifications. This preferably occurs during the initial exchange of messages, which are configured according to RAS protocol specifications.

### CROSS REFERENCE TO RELATED APPLICATIONS

This application is the US National Stage of International Application No. PCT/DE02/03932, filed Oct. 17, 2002 and claims the benefit thereof. The International Application claims the benefits of German application No. 10151720.3 filed Oct. 19, 2001, both of the applications are incorporated by reference herein in their entirety.

### FIELD OF INVENTION

The invention relates to overload protection for control units (e.g. gatekeepers) in communications networks.

### BACKGROUND OF INVENTION

The ITI-T standard H.323 defines a protocol family for uniform control of services in multimedia packet networks (in particular IP networks), i.e. of networks in which a plurality of different services can be transmitted. These services, implemented in a uniform, multimedia environment, are also called ‘multimedia applications’. The term multimedia application here covers both services such as standard telephony (‘Voice over IP (VoIP)’) and services such as fax, telephone conferencing, video conferencing, video on demand (VoD) and the like.

The main network components of the packet-oriented H.323 are end points (units which should use applications such as a PC client), gateways (GW) for the transition to the line-oriented telephone network, multipoint control units (MCU) for controlling conferences, and gatekeepers (GK).

A gatekeeper in this instance controls access to the IP network for all H.323 network components (end points, GW, MCU) belonging to its zone. A GK is assigned the following functions:

1) Admission control (network access control)

2) Call authorization (authentication of individual traffic flows—also called ‘connections’, particularly in the case of VOIP)

3) Address translation (conversion between dialing information and IP address)

4) Call control signaling (control of the setup and clearing of traffic flows and of user features)

5) GK communication (communication with the GKs of other zones).

Functions 3), 4) and 5) are based on the processing of H.225 call signaling messages. If the gatekeeper becomes overloaded in a particular time interval as a result of an excess of H.225 signaling messages and hence messages have to be rejected, many gatekeeper functions and in consequence many of the services referred to above are no longer available, or are available only on a restricted basis, in particular for the end points of the gatekeeper's zone.

However, unrestricted availability of services such as telephone accessibility takes a high priority and is exceptionally important for carrier-grade VOIP.

Until now no mechanisms have been known which can resolve the problem described. The relevant H.323 standard is not concerned with the topic of signaling overload of network components such as the gatekeeper, and hence does not describe any protocol-specific protection mechanisms for overload.

### SUMMARY OF INVENTION

The object of the invention is to describe a way, including in the event of signaling overload of a gatekeeper, of keeping the assigned services as far as possible unrestrictedly available.

It is proposed to protect gatekeepers against H.225 signaling overload. Connection requests with no prospect of success should be rejected in accordance with the H.323 protocol provisions and in particular in accordance with the RAS protocol provisions.

All resources already occupied are released in the end points. Intelligent end points additionally address a second (secondary) gatekeeper assigned to them in the event of overload of their (primary) gatekeeper and hence perform a dynamic (as distinct from the simpler static) load distribution.

In the H.323 standard every new connection is set up as follows when using a gatekeeper (GK=gatekeeper; EP=end point):

| | | | | |
|---|---|---|---|---|
| EP₁ | | GK | | EP₂. |
| \| | ----ARQ --> | \| | | \| |
| \| | <-- ACF ---- | \| | | \| |
| \| | ----SETUP --> | \| | | \| |
| \| | | \| | ----SETUP --> | \| |
| \| | | \| | | \| |

Each new connection wishing to set up an end point (EP₁ in the diagram) is initially displayed to the gatekeeper by an Admission Request ARQ message structured in accordance with the RAS protocol (Registration, Admission, Status). If this has been positively acknowledged with the RAS message Admission Confirm ACF, the end point continues in the connection setup with a SETUP message structured in accordance with the H.225 standard.

According to the invention a gatekeeper identifies an overload before the (TCP-based) H.225 messages by analyzing (UDP-based) RAS messages and consequently reduces the load (e.g. measured as connections in a predefined time unit).

Advantageously in the course of RAS signaling the gatekeeper rejects connection requests having no prospect of success, before the occurrence of expensive signaling and processing of TCP-based H.225 call signaling messages in the network and in individual network components, which would then have to be rejected during connection setup because of overload.

Advantageously in an event-controlled implementation of the invention excessive signaling load on a gatekeeper with a low internal processor performance is identified and consequently reduced using a suitable mechanism. An event is deemed to be the arrival of particular messages, in particular the ARQ message.

The limit value as of which signaling overload applies is for example defined as the number of maximum possible connection attempts per second which the gatekeeper can process.

Fixed or freely administered threshold values serve to reduce connection requests, e.g. on a percentage basis. The percentage of connections to be rejected can here again be freely administered or permanently linked to a threshold value.

A solution proving to be very flexible is one in which the higher the threshold value—i.e. the nearer the current signaling load comes to a predefined maximum load—the more connection requests are rejected.

By means of the invention a simple method is described for determining the H.225 signaling load of a gatekeeper based on the first UDP-based RAS message ARQ. Additionally it sets out how a gatekeeper can reject connection requests in a controlled manner in the event of an overload. The invention is event-controlled and hence avoids cyclical processes which could have a negative effect on the processor load of the gatekeeper. Since connection requests in the event of an overload are already rejected before the H.225 Call Setup message is sent, the unsuccessful setup of TCP connections which increase the network load and tie up important resources can be avoided.

### BRIEF DESCRIPTION OF THE DRAWINGS

Further exemplary embodiments of the invention are shown in the figures. These show:

FIG. 1 an arrangement for carrying out the inventive method, which includes a gatekeeper GK with a database DB as well as a client EP and a gateway GW,

FIG. 2 a table containing threshold-dependent connection rejection values for reducing the overload on a gatekeeper.

### DETAILED DESCRIPTION OF INVENTION

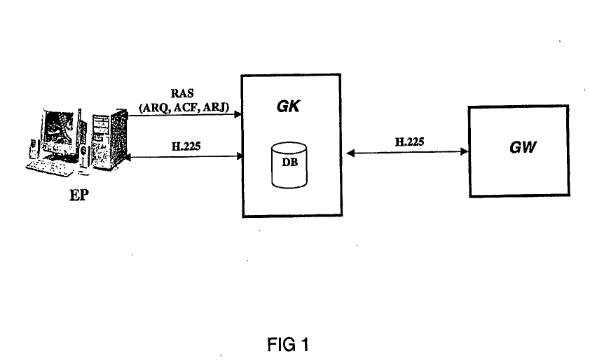

FIG. 1 shows the connection setup of the end point EP to the gateway GW. The end point is registered with the gatekeeper GK. It therefore sends an RAS message ARQ to this gatekeeper. This message acts as an event in the gatekeeper, by means of which processing of the message according to the invention is triggered. The connection setup request is either confirmed with a message ACF or rejected with a message ARJ. Only in the event of confirmation is the connection setup between end point EP and gateway GW continued by exchanging further H.225 messages.

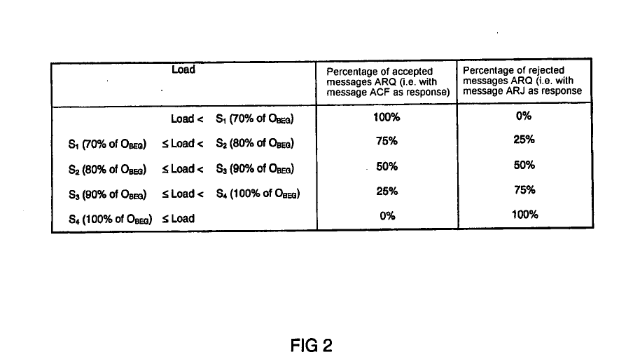

The table shown in FIG. 2 describes the processing of incoming connection requests as a function of the current signaling load of the gatekeeper. This table is preferably implemented in the call processing machine of the gatekeeper and updated with every admission request ARQ received from an end point or gateway. The gatekeeper calculates the current signaling load for each newly arrived ARQ message of an end point, by means of which message a new connection setup request is displayed, and compares the said signaling load with defined threshold values. If the current load is greater than one of these threshold values, the gatekeeper rejects the fixed percentage of new connections.

In the following this inventive overload control in described in a detailed exemplary embodiment.

Overload is defined by a value, to be determined, O_{BEG}=maximum number of connection requests per second which the gatekeeper can process. This figure can be determined, for example, by load tests on a specific machine.

The time interval T_{OVL} is used to calculate the current signaling load. It is specified, for example, in seconds. When calculating the load all connection requests which arrive within this time interval are taken into account. By default, 1 second is used.

In the counter C_{ARQ} all admission requests ARQ coming from an end point or gateway within the defined time interval T_{OVL} are recorded. The H.225 signaling load here is identified with the number of ARQs in the defined time interval T_{OVL}. This is possible for the reasons mentioned in the introduction.

In the case of the (preferably every) admission request ARQ of an end point or gateway, the gateway now first checks its current signaling load, before it processes the connection request.

Method for Determining the Signaling Load:

On system startup a transient time stamp T_{CURR} is initialized with the current time T_{CURR} and the transient counter C_{ARR} with 0.

1. If a message ARQ is received by the gatekeeper, the counter C_{ARQ} is increased by 1 and the current time T_{CURR} is determined.

2. If the defined time interval T_{OVL} has elapsed (i.e. T_{CURR-T}_{RANS}>=T_{OVL}) then

2.1. the current load is calculated using Load=c_{ARQ}/(T_{TRANS}−T_{CURR});

2.2 the transient time stamp T_{TRANS} is set to the current time T_{CURR};

2.3 the counter C_{ARQ} is zeroed.

When the next message ARQ is received the same procedure is carried out.

This mechanism is event-controlled, i.e. it is executed only when messages ARQ arrive. A cyclical process does not need to be implemented in the gatekeeper. Advantageously as a result, only a small amount of CPU (Central Processing Unit) time is used for this method.

Rejection of Connection Requests Because of Signaling Overload:

If the current load is below the lowest defined threshold value, a connection request is processed as normal and the connection setup is continued by the gatekeeper with the RAS message Admission Confirm ACF or Admission Reject ARJ.

If the current load of the gatekeeper is above a fixed threshold value, only a defined percentage of the incoming connection requests is processed, while the remaining connection requests are rejected with the RAS message Admission Reject ARJ. The message ARJ here contains preferably the value “resourceUnavailable” as a reason for triggering. The number of rejected connection requests is geared here to the defined percentage as per FIG. 2.

In conclusion it should be stressed that the description of the components relevant to the invention is in principle not to be understood as restrictive. For a person skilled in the relevant art it is particularly apparent that terms such as ‘end point’, ‘gateway’ or ‘gatekeeper’ are to be understood functionally and not physically. Thus they can for instance also be implemented in whole or in part in software and/or be distributed across several physical devices.

1-12. (canceled)

13. A method for overload protection of a control unit of a packet-oriented communications network, comprising a plurality of disjunct classes defined by threshold values formed by taking into account a predefined maximum load of the control unit, the method comprising:
recording the current load of the control unit by counting defined events;
comparing the current load with at least one of the threshold values; and
reducing the load of the control unit using a suitable mechanism when at least one of the threshold values is exceeded, the mechanism for each class being formed as a homogeneous suitable action.

14. A method according to claim 13, wherein the events are arrivals of messages.

15. A method according to claim 14, wherein the threshold values are formed by taking into account the maximum number of messages which can be processed without overload.

16. A method according to claim 14, wherein the suitable action is structured as non-processing of at least one message.

17. A method according to claim 16, wherein a number of messages specified on a percentage basis is not processed.

18. A method according to claim 16, wherein the nearer the current load comes to the predefined maximum load of the control unit, the more messages are not processed.

19. A method according to claim 13, wherein the threshold values and/or the suitable actions are optionally fixed or freely administered.

20. A method according to claim 13, wherein the current load is recorded cyclically in predefined time units.

21. A method according to claim 14, wherein the messages are requests for admission of transmissions in the communications network.

22. A method according to claim 16, wherein the non-processing of the message is performed as rejection of the message.

23. A method according to claim 15, wherein the suitable action is structured as non-processing of at least one message.

24. A method according to claim 17, wherein the nearer the current load comes to the predefined maximum load of the control unit, the more messages are not processed.

25. A computer program product, comprising software code sections to perform a method for overload protection of a control unit of a packet-oriented communications network, the network comprising a plurality of disjunct classes defined by threshold values formed by taking into account a predefined maximum load of the control unit, the method comprising:
recording the current load of the control unit by counting defined events;
comparing the current load with at least one of the threshold values; and
reducing the load of the control unit using a suitable mechanism when at least one of the threshold values is exceeded, the mechanism for each class being formed as a homogeneous suitable action.

26. A device for performing a method for overload protection of a control unit of a packet-oriented communications network, the network comprising a plurality of disjunct classes defined by threshold values formed by taking into account a predefined maximum load of the control unit, the method comprising:
recording the current load of the control unit by counting defined events;
comparing the current load with at least one of the threshold values; and
reducing the load of the control unit using a suitable mechanism when at least one of the threshold values is exceeded, the mechanism for each class being formed as a homogeneous suitable action.

27. A device according to claim 26, wherein the device is a control unit or an end point.

28. A device according to claim 26, wherein the device is part of a communications network.
